(19) United States
(12) Patent Application Publication
(10) Pub. No.: US 2023/0131135 A1
(43) Pub. Date: Apr. 27, 2023

(54) Uplink MU-MIMO Functional Split Between Radio Unit And Distributed Unit

(71) Applicant: Meta Platforms, Inc., Menlo Park, CA (US)

(72) Inventors: Mustafa Emin Sahin, Porter Ranch, CA (US); Krishna Srikanth Gomadam, San Jose, CA (US); Djordje Tujkovic, Los Altos, CA (US); Anoop Singh Tomar, Santa Clara, CA (US)

(21) Appl. No.: 17/967,187

(22) Filed: Oct. 17, 2022

Related U.S. Application Data
(60) Provisional application No. 63/272,098, filed on Oct. 26, 2021.

(51) Int. Cl. H04B 7/0456; H04B 7/0452

(52) U.S. Cl. CPC H04B 7/0456; H04B 7/0452

(57) ABSTRACT

In one embodiment, a method includes receiving information regarding a subset of a plurality of UEs selected for uplink data transmissions per PRG and a number of layers for each of the subset of the plurality of UEs in a TTI from a DU associated with the base station, receiving uplink radio signals from the subset of the plurality of UEs, where the uplink radio signals include DMRS and user data, computing a DMRS-based channel matrix for the subset of the plurality of UEs based on the received DMRS, calculating an RX beamformer matrix based on the DMRS-based channel matrix, producing N layers or greater than N spatial streams by performing an RX beamforming and MIMO detection on the received uplink radio signals, and sending the N layers or the greater than N spatial streams to the DU.

### PRIORITY

This application claims the benefit under 35 U.S.C. § 119(e) of U.S. Provisional Patent Application No. 63/272,098, filed 26 Oct. 2021, which is incorporated herein by reference.

### TECHNICAL FIELD

This disclosure generally relates to wireless networks, and in particular, related to Multiple-Input Multiple-Output (MIMO) technologies.

### BACKGROUND

Multi-user MIMO (MU-MIMO) is a set of MIMO technologies for multipath wireless communication, in which multiple users or terminals, each radiating over one or more antennas, communicate with one another. In contrast, single-user MIMO (SU MIMO) involves a single multi-antenna-equipped user or terminal communicating with precisely one other similarly equipped node. MU-MIMO algorithms enhance MIMO systems where connections among users count greater than one. Downlink MU-MIMO is a case where a base station transmits to multiple receivers within the wireless network. Examples of advanced-transmit processing for downlink MU-MIMO are interference-aware precoding and space-division multiple access (SDMA)-based downlink user scheduling. For advanced-transmit processing, channel state information has to be known at the transmitter. Knowledge of channel state information enables accurate beamforming and leads to an improved capacity. Therefore, methods to obtain channel state information at the transmitter are of significant importance. Downlink MU-MIMO systems have an outstanding advantage over SU-MIMO systems, especially when the number of antennas at the transmitter is larger than the number of antennas at each receiver (user). Uplink MU-MIMO uses the multi-antenna technology of the transmitter and receiver to transmit data simultaneously on multiple spatial streams over the same channel. Multiple data streams in UL MU-MIMO come from multiple User Equipments (UEs) connected to the base station. For MU-MIMO, a base station is the transmitter, and a user is the receiver for downlink connections, and vice versa for uplink connections.

### SUMMARY OF PARTICULAR EMBODIMENTS

Particular embodiments described herein relate to systems and methods for receiving uplink multi-user multiple-input-multiple-output (UL MU-MIMO) data streams based on Demodulation Reference Signal (DMRS)-based channel estimations. Due to the mobility of User Equipments (UEs) channel may change in a short period of time. Interference caused by transmissions of UEs in adjacent cells also tends to change very frequently. Legacy Time Division Duplexing (TDD) base stations perform channel estimation using Sounding Reference Signals (SRS) received from the UEs for calculating an UL beamformer matrix. The estimated channel matrix may be used for calculating UL beamformer matrix per physical resource block group (PRG). SRS based approach may introduce inter-layer interference because channel conditions may change in a duration between a time instance of receiving an SRS from a UE and a time instance of receiving UL payload data from the UE using UL MU-MIMO. Moreover, SRS based approach is not capable of coping with intercell interference due to the fact that SRS does not reflect the interference conditions at the instance of receiving UL payload data. A solution for performing a channel estimation based on the DMRS and calculating an UL beamformer matrix at a Radio Unit (RU) upon receiving UL MU MIMO signals is proposed to improve the performance of UL MU MIMO in cellular networks.

In particular embodiments, a radio unit (RU) associated with a base station of a wireless network may receive SRS from the plurality of UEs. The RU may compute a channel matrix for the plurality of UEs based on the SRS received from the plurality of UEs. The channel matrix may be between a receive antenna array for the base station and a UE antenna transmitting SRS. The channel matrix may be computed by an SRS-based least squares channel estimation. The RU may estimate a strength for each of a plurality of pre-determined beams for each antenna of each of the plurality of UEs by performing a two-dimensional discrete Fourier transform (2D-DFT) on the channel matrix. The RU may determine a list of strongest beams for each antenna of each of the plurality of UEs. The RU may send the channel matrix to a distributed unit (DU) associated with the base station. The RU may also send the list of strongest beams and their corresponding complex values for each antenna of each of the plurality of UEs, and a rank for each of the plurality of UEs. The rank for each of the plurality of UEs may be determined based on the strongest beams for the UE. In particular embodiments, the DU may select a subset of the plurality of UEs by performing a UE grouping and scheduling based on the channel matrix for the plurality of UEs, the list of strongest beams and their corresponding strengths for each of the plurality of UEs, and the rank for each of the plurality of UEs.

In particular embodiments, the RU may receive information regarding a subset of the plurality of UEs selected for uplink data transmissions per PRG and a number of layers for each of the subset of the plurality of UEs in a TTI from the DU. The RU may receive uplink radio signals from the subset of the plurality of UEs. The uplink radio signals may be UL MU-MIMO signals. The uplink radio signals may comprise demodulation reference signals (DMRS) and user data. The RU may compute a DMRS-based channel matrix for the subset of the plurality of UEs based on the received DMRS. The RU may calculate a receive (RX) beamformer matrix based on the DMRS-based channel matrix. The RX beamformer matrix may be calculated for the number of layers for each of the subset of the plurality of UEs. The RU may produce N layers or greater than N spatial streams by performing an RX beamforming and MIMO detection on the received uplink radio signals. The RX beamforming and MIMO detection may be performed using the calculated RX beamformer matrix. The RU may send the N layers or the greater than N spatial streams to the DU. The DU may perform demodulation and decoding on the N separated layers or the greater than N spatial streams to acquire the user data.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example architecture for open Radio Access Network (RAN).

FIG. 2 illustrates an example flow for UL MU-MIMO with a conventional functional split for an open RAN.

FIG. 3 illustrates an example flow for UL MU-MIMO for an open RAN when an RU performs an SRS-based channel estimation.

FIG. 4 illustrates a first example flow for UL MU-MIMO for an open RAN when an RU calculates an RX beamformer matrix based on DMRS-based channel matrix.

FIG. 5 illustrates a second example flow for UL MU-MIMO for an open RAN when an RU calculates an RX beamformer matrix based on DMRS-based channel matrix.

FIG. 6 illustrates an example method 500 for producing layers from UL signals based on DMRS-based channel matrix at an RU of an open RAN.

FIG. 7 illustrates an example computer system.

### DESCRIPTION OF EXAMPLE EMBODIMENTS

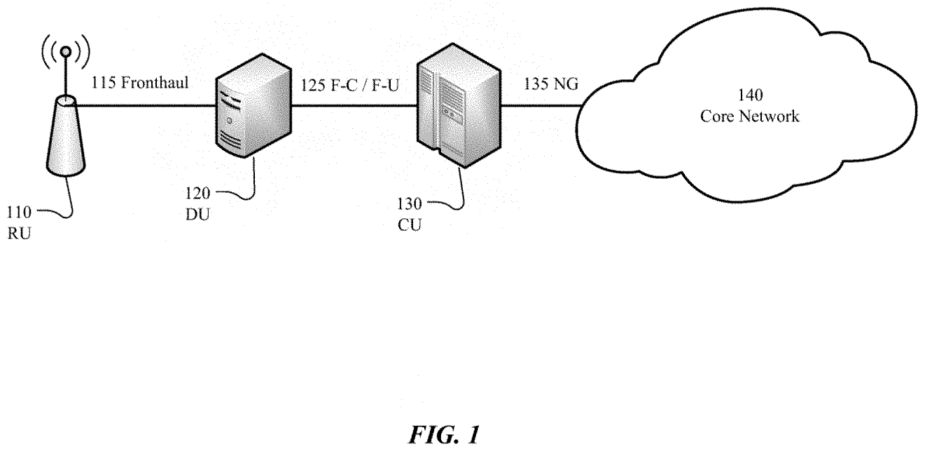

FIG. 1 illustrates an example architecture for open RAN. A functional split RAN architecture has been proposed for 5G networks, where each of one or more radio units (RUs) 110 is connected with a distributed unit (DU) 120 via a fronthaul 115. An RU 110 may handle the digital front end (DFE) and parts of the physical (PHY) layer as well as the digital beamforming functionality. A DU 120 may locate close to the RU 110 and may comprise a layer-2 (L2) module that runs radio link control (RLC) and media access control (MAC) layers and a layer-1 (L1) module that runs parts of the PHY layer. The DU 120 may include a subset of eNB/gNB functions depending on the functional split option. The DU 120 may be controlled by a CU 130. The CU 130 may be a centralized unit that runs radio resource control (RRC) and packet data convergence protocol (PDCP) layers. A typical gNB may consist of a CU 130 and a DU 120, which are connected via F-C and F-U interfaces 125 for control plane and user plane respectively. The typical gNB may further consist of one or more RUs 110. A CU 130 with multiple DUs 120 may support multiple gNBs. The CU 130 may be connected to the core network 140 via NG interface 135. Functional split between RU 110 and DU 120 may bring a number of benefits: (1) cost reduction—less intelligent RU may cost less, (2) ability to coordinate the use of resources between sectors s—the ability may help to enable features like Coordinated Multipoint (CoMP), and (3) resource pooling gains—computationally expensive processing requirements of multiple sectors may be pooled in the DU 120. The fronthaul 115 between the RU 110 and the DU 120 may be a bottleneck. In a typical open RAN, fronthaul latency may be constrained to 100 microsections. Although this disclosure describes a particular RAN architecture, this disclosure contemplates any suitable RAN architecture.

Due to the mobility of UEs, channel may change in a short period of time. Interference caused by transmissions of UEs in adjacent cells also tends to change very frequently. Legacy Time Division Duplexing (TDD) base stations perform channel estimations using Sounding Reference Signals (SRSs) received from the UEs for calculating an UL MU-MIMO beamformer matrix. The estimated channel matrix may be used for calculating UL beamformer matrix per physical resource block group (PRG). SRS based approach may introduce inter-layer interference because channel condition may change in a duration between a time instance of receiving an SRS from a UE and a time instance of receiving UL payload data from the UE using UL MU-MIMO. Moreover, SRS based approach is not capable of coping with intercell interference due to the fact that SRS does not reflect the interference conditions at the instance of receiving UL payload data.

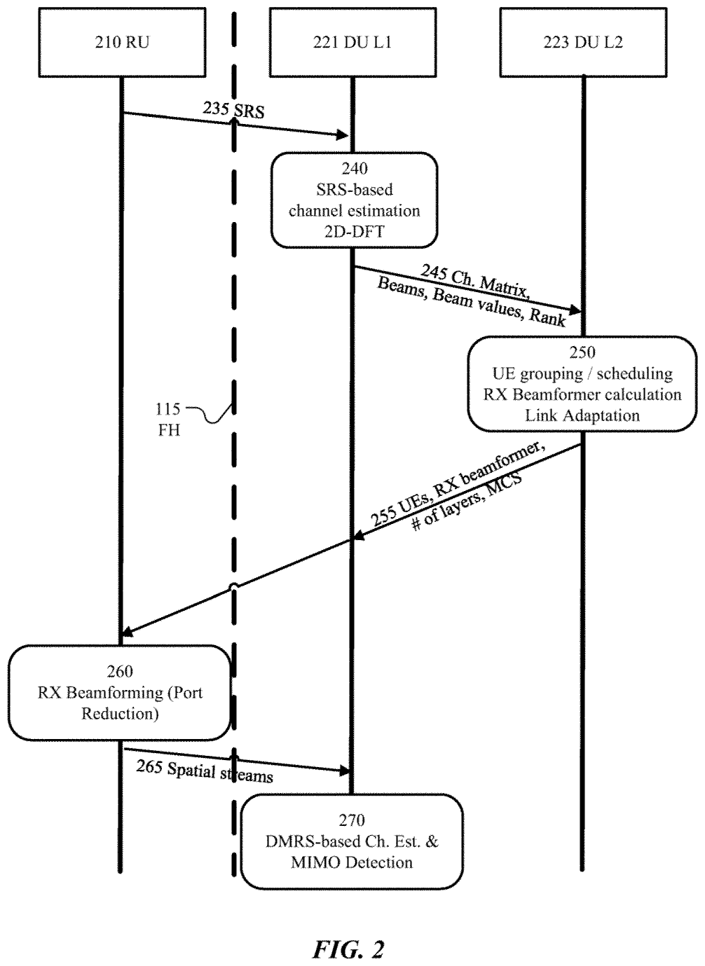

FIG. 2 illustrates an example flow for UL MU-MIMO with a conventional functional split for an open RAN. An RU 210 associated with a gNB may receive SRS from a plurality of UEs associated with the gNB. At step 235, the RU 210 may send the raw SRS samples to a L1 221 of a DU associated with the gNB over the fronthaul interface 115. At step 240, the L1 221 may perform an SRS-based channel estimation to produce an SRS-based channel matrix using the raw SRS samples received from the RU 210. The SRS-based channel matrix may be computed by an SRS-based least squares channel estimation. The L1 221 may estimate strengths for a plurality of pre-determined beams for each antenna of each of the plurality of UEs by performing a 2D-DFT on the SRS-based channel matrix for each of the plurality of UEs. At step 245, the L1 221 may send the SRS-based channel matrix along with a list of k strongest beams and their complex values, and a rank for each of the plurality of UEs to an L2 223 of the DU.

At step 250, the L2 223 may perform a UE grouping and scheduling for UL transmissions to determine a subset of the plurality of UEs that maximizes a sum of weighted data rate for each UL PRG. The L2 223 may use the received SRS-based channel matrix along with a list of k strongest beams and their strengths, and a rank for each of the plurality of UEs for the UE grouping and scheduling. The L2 223 may also calculate a beamformer matrix per PRG for the subset of the plurality of UEs based on the SRS-based channel matrix. The L2 223 may further perform a link adaptation, which may determine modulation and coding scheme (MCS) for each of the subset of the plurality of UEs for a TTI. The L2 223 may calculate an initial MCS as a function of an effective signal-to-interference-and-noise-ratio (SINR) for each UE. The L2 223 may determine a Transport Block (TB) size as a function of the initial MCS and a number of resource blocks allocated to the UE during the link adaptation.

At step 255, the L2 223 may send the list of the subset of the plurality of UEs and a beamformer matrix per PRG to the L1 221. The L2 223 may also send a number of layers and MCS determined for each of the subset of the plurality of UEs for TTI to the L1 221. The L1 221 may relay the information received from the L2 223 to the RU 210 over the fronthaul 115.

At step 260, the RU 210 may receive uplink radio signals from the subset of the plurality of UEs. The RU 210 may perform an RX beamforming, a.k.a. a port reduction, on the received uplink radio signals using a set of SRS-based beamforming weights from the beamformer matrix. The output of the RX beamforming may be a set of ‘spatial streams’ rather than ‘layers’ because the output may have some residual interference. The number of spatial streams may be greater than or equal to the number of layers. Some residual interference may exist between the spatial streams. The SRS signals received from the plurality of UEs may have become, at least partially, outdated by the point the RU 210 receives the uplink radio signals due to changes in the channel. TX/RX reciprocity calibration issues may exist as well. Those factors may contribute to inter-layer interference. Also, inter-cell interference from UEs in neighbor cells may also occur.

At step 265, the RU 210 may send the spatial streams produced by the RX beamforming to the L1 221 of the DU. At step 270, the L1 221 may perform a DMRS-based channel estimation to produce a DMRS-based channel matrix. The L1 221 may also perform a MIMO detection on the received spatial streams using the DMRS-based channel matrix to produce separated layers. The L1 221 may further perform demodulation and decoding on the separated layers to acquire the user data in the uplink radio signals.

### DU-Centric Approach

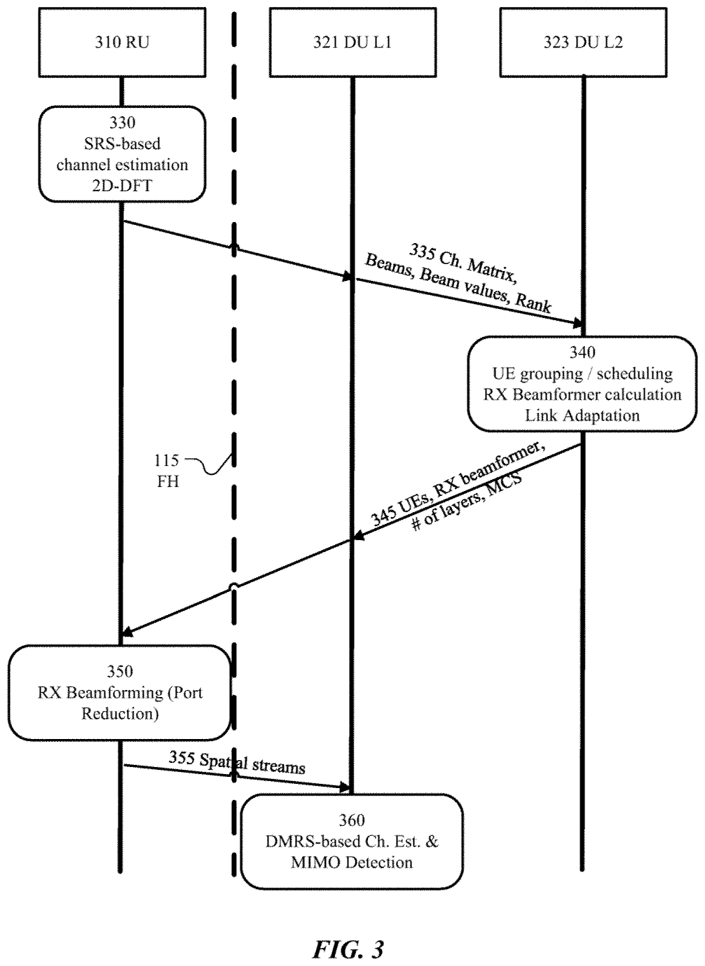

FIG. 3 illustrates an example flow for UL MU-MIMO for an open RAN when an RU performs an SRS-based channel estimation. An RU 310 associated with a gNB may receive SRS from a plurality of UEs associated with the gNB. At step 330, the RU 310 may perform an SRS-based channel estimation to produce an SRS-based channel matrix using the received SRS. The SRS-based channel matrix may be computed by an SRS-based least squares channel estimation. The RU 310 may estimate strengths for a plurality of pre-determined beams for each antenna of each of the plurality of UEs by performing a 2D-DFT on the SRS-based channel matrix for each of the plurality of UEs. At step 335, the RU 310 may send the SRS-based channel matrix along with a list of k strongest beams and their complex values, and a rank for each of the plurality of UEs to an L1 321 of a DU associated with the gNB over the fronthaul interface 115. The L1 321 may forward the SRS-based channel matrix along with the list of k strongest beams and their complex values, and the rank for each of the plurality of UEs to an L2 323 of the DU.

At step 340, the L2 323 may perform a UE grouping and scheduling for UL transmissions to determine a subset of the plurality of UEs that maximizes a sum of weighted data rate for each UL PRG. The L2 323 may use the received SRS-based channel matrix along with a list of k strongest beams and their complex values, and a rank for each of the plurality of UEs for the UE grouping and scheduling. The L2 323 may also calculate a beamformer matrix per PRG for the subset of the plurality of UEs based on the SRS-based channel matrix. The L2 323 may further perform a link adaptation, which may determine modulation and coding scheme (MCS) for each of the subset of the plurality of UEs for a TTI. The L2 323 may calculate an initial MCS as a function of an effective signal-to-interference-and-noise-ratio (SINR) for each UE. The L2 323 may determine a Transport Block (TB) size as a function of the initial MCS and a number of resource blocks allocated to the UE during the link adaptation.

At step 345, the L2 323 may send the list of the subset of the plurality of UEs and a beamformer matrix per PRG to the L1 321. The L2 323 may also send a number of layers and MCS determined for each of the subset of the plurality of UEs for TTI to the L1 321. The L1 321 may relay the information received from the L2 323 to the RU 310 over the fronthaul 115.

At step 350, the RU 310 may receive uplink radio signals from the subset of the plurality of UEs. The RU 310 may perform an RX beamforming, a.k.a. a port reduction, on the received uplink radio signals using a set of SRS-based beamforming weights from the beamformer matrix. The output of the RX beamforming may be a set of ‘spatial streams’ rather than ‘layers’ because the output may have some residual interference. The number of spatial streams may be greater than or equal to the number of layers. In particular embodiments, the RU 310 may perform a hybrid port reduction, in which the RU 310 may perform a first reduction using the SRS-based beamformer matrix and perform a second reduction using a DMRS-based beamformer matrix. For the second reduction, the RU 310 may compute the DMRS-based channel matrix for the subset of the plurality of UEs based on the received DMRS and calculate an RX beamformer matrix based on the DMRS-based channel matrix.

At step 355, the RU 310 may send the spatial streams produced by the port reduction to the L1 321 of the DU. At step 360, the L1 321 may perform a DMRS-based channel estimation to produce a DMRS-based channel matrix. The L1 321 may also perform a MIMO detection on the received spatial streams using the DMRS-based channel matrix to produce separated layers. The L1 321 may further perform demodulation and decoding on the separated layers to acquire the user data in the uplink radio signals.

### RU-Centric Approach

In particular embodiments, an RU 110 associated with a gNB of an open RAN may produce layers from UL MU-MIMO signals based on DMRS-based channel matrix. In particular embodiments, the RU 110 may receive SRS from the plurality of UEs. The RU 110 may compute a channel matrix for the plurality of UEs based on the SRS received from the plurality of UEs. The channel matrix may be between a receive antenna array for the base station and a UE antenna transmitting SRS. The channel matrix may be computed by an SRS-based least squares channel estimation. The RU 110 may estimate a strength for each of a plurality of pre-determined beams for each antenna of each of the plurality of UEs by performing a two-dimensional discrete Fourier transform (2D-DFT) on the channel matrix. The RU 110 may determine a list of strongest beams for each of the plurality of UEs. The RU 110 may send the channel matrix to a distributed unit (DU) 120 associated with the gNB. The RU 110 may also send the list of strongest beams and their corresponding complex values for each antenna of each of the plurality of UEs, and a rank for each of the plurality of UEs. The rank for each of the plurality of UEs may be determined based on the strongest beams for the UE. In particular embodiments, the DU 120 may select a subset of the plurality of UEs by performing a UE grouping and scheduling based on the channel matrix for the plurality of UEs, the list of strongest beams and their corresponding complex values for each of the plurality of UEs, and the rank for each of the plurality of UEs.

In particular embodiments, the RU 110 may receive information regarding a subset of the plurality of UEs selected for uplink data transmissions per PRG and a number of layers for each of the subset of the plurality of UEs in a TTI from the DU 120. The RU 110 may receive uplink radio signals from the subset of the plurality of UEs. The uplink radio signals may be UL MU-MIMO signals. The uplink radio signals may comprise demodulation reference signals (DMRS) and user data. The RU 110 may compute a DMRS-based channel matrix for the subset of the plurality of UEs based on the received DMRS. The RU 110 may calculate an RX beamformer matrix based on the DMRS-based channel matrix. The RX beamformer matrix may comprise beamforming weights for selected RX beams among a plurality of pre-determined RX beams. The RX beamformer matrix may be calculated for the number of layers for each of the subset of the plurality of UEs. The RU 110 may produce N layers or greater than N spatial streams by performing an RX beamforming and MIMO detection on the received uplink radio signals. The RX beamforming and MIMO detection may be performed using the calculated RX beamformer matrix. The RU 110 may send the N layers to the DU 120. The DU 120 may perform demodulation and decoding on the N separated layers or the greater than N spatial streams to acquire the user data.

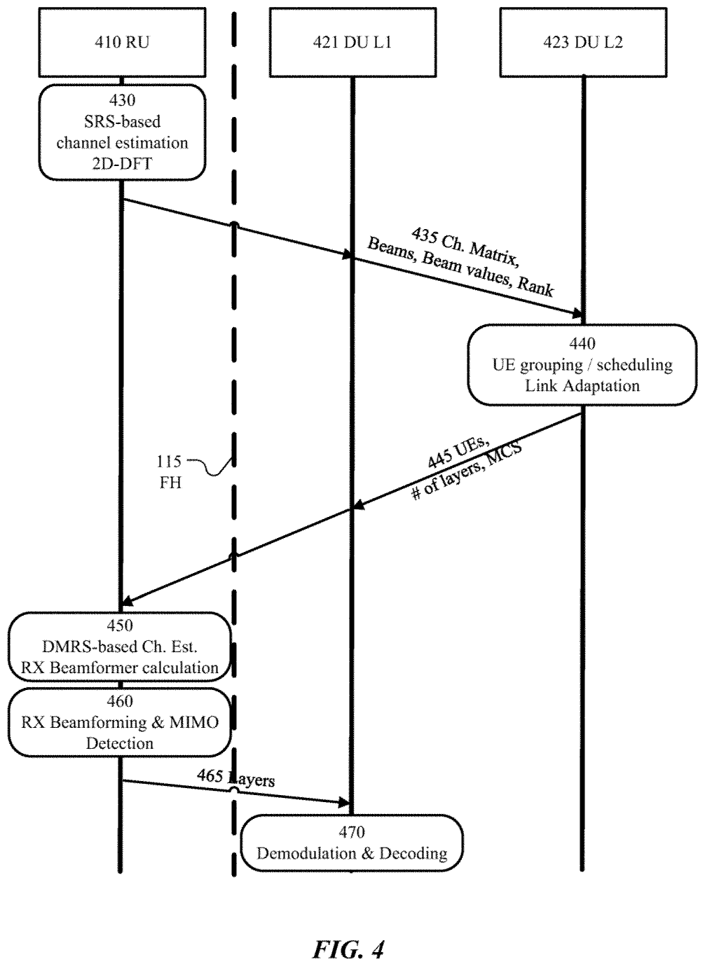

FIG. 4 illustrates a first example flow for UL MU-MIMO for an open RAN when an RU calculates an RX beamformer matrix based on DMRS-based channel matrix. An RU 410 associated with a gNB may receive SRS from a plurality of UEs associated with the gNB. At step 430, the RU 410 may perform an SRS-based channel estimation to produce an SRS-based channel matrix using the received SRS. The SRS-based channel matrix may be computed by an SRS-based least squares channel estimation. The RU 410 may estimate strengths for a plurality of pre-determined beams for each antenna of each of the plurality of UEs by performing a 2D-DFT on the SRS-based channel matrix for each of the plurality of UEs. At step 435, the RU 410 may send the SRS-based channel matrix along with a list of k strongest beams and their complex values, and a rank for each of the plurality of UEs to an L1 421 of a DU associated with the gNB over the fronthaul interface 115. The L1 421 may forward the SRS-based channel matrix along with the list of k strongest beams and their complex values, and the rank for each of the plurality of UEs to an L2 423 of the DU.

At step 440, the L2 423 may perform a UE grouping and scheduling for UL transmissions to determine a subset of the plurality of UEs that maximizes a sum of weighted data rate for each UL PRG. The L2 423 may use the received SRS-based channel matrix along with a list of k strongest beams and their complex values, and a rank for each of the plurality of UEs for the UE grouping and scheduling. The L2 423 may also perform a link adaptation, which may determine modulation and coding scheme (MCS) for each of the subset of the plurality of UEs for a TTI. The L2 423 may calculate an initial MCS as a function of an effective signal-to-interference-and-noise-ratio (SINR) for each UE. The L2 423 may determine a Transport Block (TB) size as a function of the initial MCS and a number of resource blocks allocated to the UE during the link adaptation.

At step 445, the L2 423 may send the list of the subset of the plurality of UEs per PRG to the L1 421. The L2 423 may also send a number of layers and MCS determined for each of the subset of the plurality of UEs for TTI to the L1 421. The L1 421 may relay the information received from the L2 423 to the RU 410 over the fronthaul 115.

At step 450, the RU 410 may receive uplink radio signals from the subset of the plurality of UEs. The uplink radio signals may comprise demodulation reference signals (DMRS) and user data. The RU 410 may compute a DMRS-based channel matrix for the subset of the plurality of UEs based on the received DMRS. The RU 410 may calculate an RX beamformer matrix based on the DMRS-based channel matrix. The RX beamformer matrix may be calculated for the number of layers for each of the subset of the plurality of UEs. At step 460, the RU 410 may produce N layers or greater than N spatial streams by performing RX beamforming and MIMO detection on the received uplink radio signals. The RX beamforming and MIMO detection may be performed using the calculated RX beamformer matrix.

At step 465, the RU 410 may send the N layers or the greater than N spatial streams produced by the RX beamforming and MIMO detection to the L1 421 of the DU. At step 470, the L1 421 may perform a demodulation and decoding on the N layers or the greater than N spatial streams to acquire the user data in the uplink radio signals.

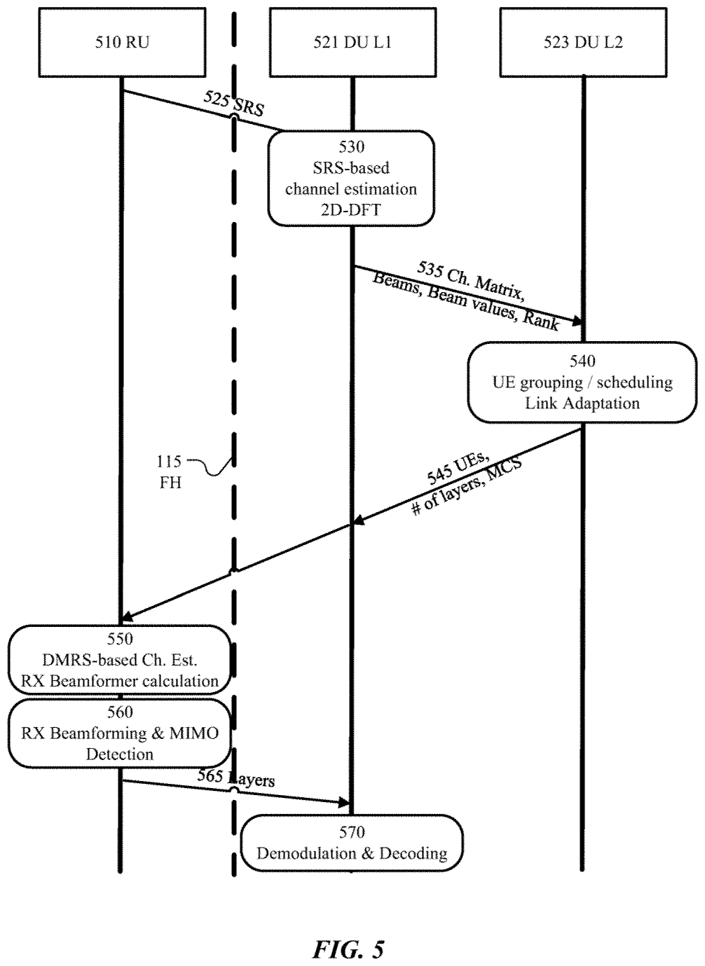

FIG. 5 illustrates a second example flow for UL MU-MIMO for an open RAN when an RU calculates an RX beamformer matrix based on DMRS-based channel matrix. An RU 510 associated with a gNB may receive SRS from a plurality of UEs associated with the gNB. At step 525, the RU 510 may send the raw SRS samples to a L1 521 of a DU associated with the gNB over the fronthaul interface 115. At step 530, the L1 521 may perform an SRS-based channel estimation to produce an SRS-based channel matrix using the raw SRS samples received from the RU 510. The SRS-based channel matrix may be computed by an SRS-based least squares channel estimation. The L1 521 may estimate strengths for a plurality of pre-determined beams for each antenna of each of the plurality of UEs by performing a 2D-DFT on the SRS-based channel matrix for each of the plurality of UEs. At step 535, the L1 521 may send the SRS-based channel matrix along with a list of k strongest beams and their complex values, and a rank for each of the plurality of UEs to an L2 523 of the DU.

At step 540, the L2 523 may perform a UE grouping and scheduling for UL transmissions to determine a subset of the plurality of UEs that maximizes a sum of weighted data rate for each UL PRG. The L2 523 may use the received SRS-based channel matrix along with a list of k strongest beams and their complex values, and a rank for each of the plurality of UEs for the UE grouping and scheduling. The L2 523 may also perform a link adaptation, which may determine modulation and coding scheme (MCS) for each of the subset of the plurality of UEs for a TTI. The L2 523 may calculate an initial MCS as a function of an effective signal-to-interference-and-noise-ratio (SINR) for each UE. The L2 523 may determine a Transport Block (TB) size as a function of the initial MCS and a number of resource blocks allocated to the UE during the link adaptation.

At step 545, the L2 523 may send the list of the subset of the plurality of UEs per PRG to the L1 521. The L2 523 may also send a number of layers and MCS determined for each of the subset of the plurality of UEs for TTI to the L1 521. The L1 521 may relay the information received from the L2 523 to the RU 510 over the fronthaul 115.

At step 550, the RU 510 may receive uplink radio signals from the subset of the plurality of UEs. The uplink radio signals may comprise demodulation reference signals (DMRS) and user data. The RU 510 may compute a DMRS-based channel matrix for the subset of the plurality of UEs based on the received DMRS. The RU 510 may calculate an RX beamformer matrix based on the DMRS-based channel matrix. The RX beamformer matrix may be calculated for the number of layers for each of the subset of the plurality of UEs. At step 560, the RU 510 may produce N layers or greater than N spatial streams by performing RX beamforming and MIMO detection on the received uplink radio signals. The RX beamforming and MIMO detection may be performed using the calculated RX beamformer matrix.

At step 565, the RU 510 may send the N layers or the greater than N spatial streams produced by the RX beamforming and MIMO detection to the L1 521 of the DU. At step 570, the L1 521 may perform a demodulation and decoding on the N layers or the greater than N spatial streams to acquire the user data in the uplink radio signals.

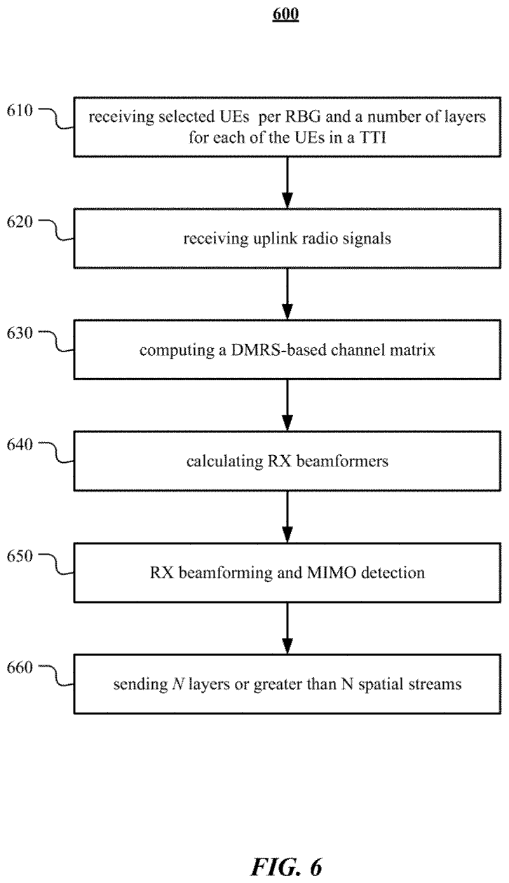

FIG. 6 illustrates an example method 600 for producing layers from UL signals based on DMRS-based channel matrix at an RU of an open RAN. The method may begin at step 610, where an RU associated with a base station may receive information regarding a subset of a plurality of UEs selected for uplink data transmissions per PRG and a number of layers for each of the subset of the plurality of UEs in a TTI, from a DU associated with the base station. At step 620, the RU may receive uplink radio signals from the subset of the plurality of UEs. The uplink radio signals comprise DMRS and user data. At step 630, the RU may compute a DMRS-based channel matrix for the subset of the plurality of UEs based on the received DMRS. At step 640, the RU may calculate an RX beamformer matrix based on the DMRS-based channel matrix. At step 650, the RU may produce N layers or greater than N spatial streams by performing an RX beamforming and MIMO detection on the received uplink radio signals. At step 660, the RU may send the N layers or the greater than N spatial streams to the DU. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for producing layers from UL MU-MIMO signals based on DMRS-based channel matrix at an RU of an open RAN including the particular steps of the method of FIG. 6, this disclosure contemplates any suitable method for producing layers from UL MU-MIMO signals based on DMRS-based channel matrix at an RU of an open RAN including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

### Systems and Methods

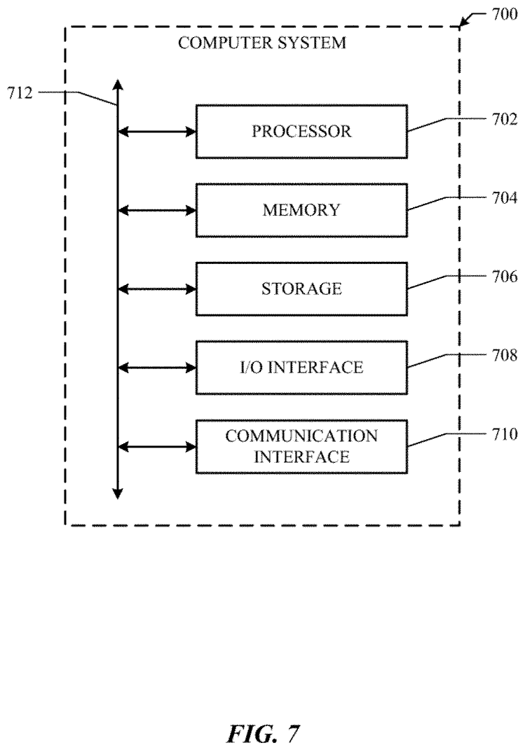

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing devices associated with a base station of a wireless network:
receiving, from a distributed unit (DU) associated with the base station, information regarding a subset of a plurality of user equipments (UEs) selected for uplink data transmissions per physical resource block group (PRG) and a number of layers for each of the subset of the plurality of UEs in a transmission time interval (TTI);
receiving uplink radio signals from the subset of the plurality of UEs, wherein the uplink radio signals comprise demodulation reference signals (DMRS) and user data;
computing a DMRS-based channel matrix for the subset of the plurality of UEs based on the received DMRS;
calculating a receive (RX) beamformer matrix based on the DMRS-based channel matrix;
producing N layers or greater than N spatial streams by performing an RX beamforming and Multiple-Input Multiple-Output (MIMO) detection on the received uplink radio signals; and
sending, to the DU, the N layers or the greater than N spatial streams.

2. The method of claim 1, further comprising:
receiving, from the plurality of UEs, Sounding Reference Signal (SRS);
computing a channel matrix for the plurality of UEs based on the SRS received from the plurality of UEs, wherein the channel matrix is between an antenna array for the base station and the plurality of UEs; and
sending, to the DU, the channel matrix.

3. The method of claim 2, wherein the channel matrix is computed by an SRS-based least squares channel estimation.

4. The method of claim 2, further comprising:
estimating, for each antenna of each of the plurality of UEs, a complex value for each of a plurality of pre-determined beams by performing a two-dimensional discrete Fourier transform (2D-DFT) on the channel matrix;
determining, for each antenna of each of the plurality of UEs, a list of strongest beams; and
sending, to the DU, for each antenna of each of the plurality of UEs, the list of the strongest beams and their corresponding complex values, and a rank for each of the plurality of UEs.

5. The method of claim 4, wherein the rank for each of the plurality of UEs is determined based on the strongest beams for the UE.

6. The method of claim 4, wherein the DU selects the subset of the plurality of UEs by performing UE grouping and UE scheduling based on the channel matrix for the plurality of UEs, the list of the strongest beams and their corresponding complex values for each of the plurality of UEs, and the rank for each of the plurality of UEs.

7. The method of claim 1, wherein the RX beamformer matrix is calculated for the number of layers for each of the subset of the plurality of UEs.

8. The method of claim 1, wherein the RX beamforming and MIMO detection is performed using the calculated RX beamformer matrix.

9. The method of claim 1, wherein the DU performs demodulation and decoding on the N layers or the greater than N spatial streams.

10. The method of claim 1, further comprising:
receiving, from the plurality of UEs, Sounding Reference Signal (SRS); and
sending the SRS to the DU, wherein the DU computes a channel matrix for the plurality of UEs based on the SRS and estimates, for each antenna of each of the plurality of UEs, a complex value for each of a plurality of pre-determined beams by performing a 2D-DFT on the channel matrix.

11. One or more computer-readable non-transitory storage media embodying software that is operable when executed, by one or more computing devices associated with a base station of a wireless network, to:
receive, from a distributed unit (DU) associated with the base station, information regarding a subset of a plurality of user equipments (UEs) selected for uplink data transmissions per physical resource block group (PRG) and a number of layers for each of the subset of the plurality of UEs in a transmission time interval (TTI);
receive uplink radio signals from the subset of the plurality of UEs, wherein the uplink radio signals comprise demodulation reference signals (DMRS) and user data;
compute a DMRS-based channel matrix for the subset of the plurality of UEs based on the received DMRS;
calculate a receive (RX) beamformer matrix based on the DMRS-based channel matrix;
produce N layers or greater than N spatial streams by performing an RX beamforming and Multiple-Input Multiple-Output (MIMO) detection on the received uplink radio signals; and
send, to the DU, the N layers or the greater than N spatial streams.

12. The media of claim 11, wherein the software is further operable when executed to do:
receive, from the plurality of UEs, Sounding Reference Signal (SRS);
compute a channel matrix for the plurality of UEs based on the SRS received from the plurality of UEs, wherein the channel matrix is between an antenna array for the base station and the plurality of UEs; and
send, to the DU, the channel matrix.

13. The media of claim 12, wherein the channel matrix is computed by an SRS-based least squares channel estimation.

14. The media of claim 12, wherein the software is further operable when executed to do:
estimate, for each antenna of each of the plurality of UEs, a complex value for each of a plurality of pre-determined beams by performing a two-dimensional discrete Fourier transform (2D-DFT) on the channel matrix;
determine, for each antenna of each of the plurality of UEs, a list of strongest beams; and
send, to the DU, for each antenna of each of the plurality of UEs, the list of the strongest beams and their corresponding complex values, and a rank for each of the plurality of UEs.

15. The media of claim 14, wherein the rank for each of the plurality of UEs is determined based on the strongest beams for the UE.

16. The media of claim 14, wherein the DU selects the subset of the plurality of UEs by performing UE grouping and UE scheduling based on the channel matrix for the plurality of UEs, the list of the strongest beams and their corresponding complex values for each of the plurality of UEs, and the rank for each of the plurality of UEs.

17. The media of claim 11, wherein the RX beamformer matrix is calculated for the number of layers for each of the subset of the plurality of UEs.

18. The media of claim 11, wherein the RX beamforming is performed using the calculated RX beamformer matrix.

19. The media of claim 11, wherein the DU performs demodulation and decoding on the N layers or the greater than N spatial streams.

20. A system associated with a base station of a wireless network comprising:
one or more processors; and
one or more computer-readable non-transitory storage media coupled to one or more of the processors and comprising instructions operable when executed by one or more of the processors to cause the system to:
receive, from a distributed unit (DU) associated with the base station, information regarding a subset of a plurality of user equipments (UEs) selected for uplink data transmissions per physical resource block group (PRG) and a number of layers for each of the subset of the plurality of UEs in a transmission time interval (TTI);
receive uplink radio signals from the subset of the plurality of UEs, wherein the uplink radio signals comprise demodulation reference signals (DMRS) and user data;
compute a DMRS-based channel matrix for the subset of the plurality of UEs based on the received DMRS;
calculate a receive (RX) beamformer matrix based on the DMRS-based channel matrix;
produce N layers or greater than N spatial streams by performing an RX beamforming and Multiple-Input Multiple-Output (MIMO) detection on the received uplink radio signals; and
send, to the DU, the N layers or the greater than N spatial streams.
